(19) United States
(12) Patent Application Publication
(10) Pub. No.: US 2017/0062840 A1
(43) Pub. Date: Mar. 2, 2017

(54) Battery

(71) Applicants: Chia-Tien WU, Taichung City (TW); Chia-Yun WU, Taichung City (TW)

(72) Inventors: Chia-Tien WU, Taichung City (TW); Chia-Yun WU, Taichung City (TW)

(21) Appl. No.: 15/252,742

(22) Filed: Aug. 31, 2016

(30) Foreign Application Priority Data
Aug. 31, 2015 (TW) 104128561

(51) Int. Cl. H01M 6/04; H01M 10/42; H01M 2/20; H01M 2/26; H01M 4/38; H01M 4/46

(52) U.S. Cl. CPC H01M 6/045; H01M 4/381; H01M 4/466; H01M 2/204; H01M 2/206; H01M 2/26; H01M 10/4235; H01M 2004/027

(57) ABSTRACT

A battery includes at least one battery unit. The battery unit includes a negative electrode formed of magnesium or magnesium alloy, a water adsorption layer, an improved aqueous electrolyte, and a positive electrode. The water adsorption layer adsorbs the improved aqueous electrolyte. The improved aqueous electrolyte includes a catalyst and an additive. The additive is able to postpone an inert membrane forming on the negative electrode. The additive is selected from one of acrylic acid, acrylic polymer, and acrylate polymer salt. The negative electrode or the positive electrode of the battery is coated with a layer of conductive adhesive, and the conductive adhesive is attached to a solderable conductive member to enhance solderability of the negative electrode or the positive electrode. The battery of the present invention can postpone an inert membrane forming on the negative electrode and enhance the solderability of the negative electrode and the positive electrode.

### FIELD OF THE INVENTION

The present invention relates to a battery, and more particularly to a magnesium battery having an improved aqueous electrolyte. The improved aqueous electrolyte is able to postpone an inert membrane forming on the negative electrode of the magnesium battery. The present invention provides a method to enhance the solderability of the negative electrode or the positive electrode.

### BACKGROUND OF THE INVENTION

Magnesium and magnesium alloy is easy to react with water and air. A battery having magnesium or magnesium alloy as its negative electrode will form a layer of non-conductive inert membrane after the negative electrode reacts with an aqueous electrolyte. This will shorten the service life of the magnesium battery. So far, there is no approach to the problem of the inert membrane.

Additionally, it is not easy to solder the negative electrode of magnesium or magnesium alloy. In general, the negative electrode is riveted with a solderable conductive material; or treated with physical vapor deposition or chemical vapor deposition or electroplating, coated with a layer of solderable conductive material on the surface of the negative electrode. For riveting, the contact resistance is large and the contact resistance increases over time. For physical vapor deposition or chemical vapor deposition, the cost is too high. Electroplating is also expensive, and during the process of electroplating, the environment may be polluted easily.

### SUMMARY OF THE INVENTION

The primary object of the present invention is to provide a magnesium battery having an improved aqueous electrolyte to postpone an inert membrane forming on the negative electrode of the magnesium battery. Another object of the present invention is to provide a method for enhancing the solderability of the negative electrode and the positive electrode.

In order to achieve the aforesaid object to postpone an inert membrane forming on the negative electrode of the magnesium battery, through a long-term research and repeated experiments, the inventor find out that acrylic acid, acrylic polymer, and acrylate polymer salt are able to postpone an inert membrane forming on the negative electrode. That is, the improved aqueous electrolyte is added with at least one of acrylic acid, acrylic polymer, and acrylate polymer salt to prolong the service life of the negative electrode.

In order to achieve the aforesaid object to enhance the solderability of the negative electrode and the positive electrode of the magnesium battery, the method is that the negative electrode or the negative electrode is coated with a layer of the conductive adhesive and the conductive adhesive is attached to a solderable conductive member, such that the solderable conductive member can be processed with soldering. The conductive adhesive is able to isolate water and air to prevent the negative electrode and the positive electrode from oxidation. When two battery units are connected in series, the negative electrode of one battery unit is attached to the positive electrode of the other battery unit by means of the conductive adhesive.

According to an aspect of the present invention, a battery is provided. The battery comprises at least one battery unit. The battery unit comprises a negative electrode formed of magnesium or magnesium alloy, a water adsorption layer, an improved aqueous electrolyte, and a positive electrode. The water adsorption layer adsorbs the improved aqueous electrolyte. The improved aqueous electrolyte comprises a catalyst and an additive. The additive is able to postpone an inert membrane forming on the negative electrode. The additive is selected from one of acrylic acid, acrylic polymer, and acrylate polymer salt.

Preferably, the negative electrode or the positive electrode of the battery is coated with a layer of conductive adhesive, and the conductive adhesive is attached to a solderable conductive member to enhance solderability of the negative electrode or the positive electrode.

Preferably, the battery comprises a plurality of battery units. The plurality of battery units are connected in series. The negative electrode of each battery unit is attached to the positive electrode of the adjacent battery unit by means of a conductive adhesive.

The battery of the present invention can postpone an inert membrane forming on the negative electrode and enhance the solderability of the negative electrode and the positive electrode.

### BRIEF DESCRIPTION OF THE DRAWINGS

FIG. 1 is a sectional view in accordance with a first embodiment of the present invention;

FIG. 2 is a sectional view in accordance with a second embodiment of the present invention;

FIG. 3 is a sectional view in accordance with a third embodiment of the present invention;

FIG. 4 is a sectional view in accordance with a fourth embodiment of the present invention; and

FIG. 5 is a sectional view in accordance with a fifth embodiment of the present invention.

### DESCRIPTION OF THE PREFERRED EMBODIMENTS

Embodiments of the present invention will now be described, by way of example only, with reference to the accompanying drawings.

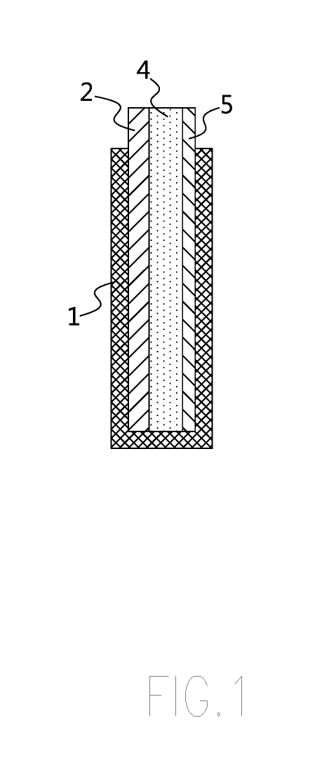

As shown in FIG. 1, the battery of the present invention includes at least one battery unit. The battery unit includes a negative electrode 2, an improved aqueous electrolyte 4, and a positive electrode 5.

FIG. 1 is a sectional view in accordance with a first embodiment of the present invention. The battery is composed of an insulation housing 1, a negative electrode 2, an improved aqueous electrolyte 4, and a positive electrode 5. The material of the negative electrode 2 includes magnesium or an alloy of magnesium as the main ingredient. The material of the positive electrode 5 includes a monomer of iron or nickel or tin or copper or titanium or silver or platinum or gold or stainless steel or carbon or nano carbon or active carbon, or an alley of iron or nickel or tin or copper or silver or titanium or platinum or gold as the main ingredient, or a compound of carbon or active carbon or nano carbon as the main ingredient. The improved aqueous electrolyte 4 includes a catalyst and an additive. The catalyst has the function of activating water. After water activation, physical and chemical properties change and hydrogen bond becomes weak to be ionized easily. The catalyst includes a nano metal, a nano oxide, a nano sulfide, a nano nitride, a nano carbide, a nano rare earth oxide, and so on. The additive includes acrylic acid, acrylic polymer, and acrylate polymer salt. Through a long-term research and repeated experiments, no matter how much the additive is (experimental range from 0.1 to 99.9%), the additive is able to postpone an inert membrane forming on the negative electrode of the magnesium battery.

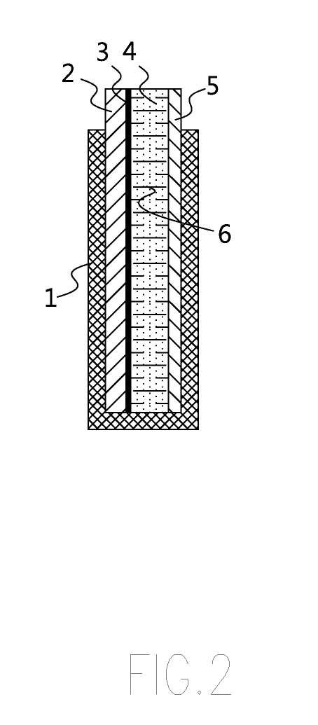

FIG. 2 is a sectional view in accordance with a second embodiment of the present invention. The battery is composed of an insulation housing 1, a negative electrode 2, a membrane 3, an improved aqueous electrolyte 4, a positive electrode 5, and a water adsorption layer 6. The positive electrode 5 is a solderable electric conductor. The membrane 3 is disposed between the negative electrode 2 and the improved aqueous electrolyte 4. The water adsorption layer 6 is placed into the improved aqueous electrolyte 4. The water adsorption layer 6 adsorbs the improved aqueous electrolyte 4, preventing the improved aqueous electrolyte 4 from leaking. The membrane 3 is an ionic conduction material and used for conducting ions and separating the negative electrode 2 from the positive electrode 5 to avoid direct reaction. The membrane 3 may be a proton exchange membrane, a nano membrane, a polymer membrane, and the like.

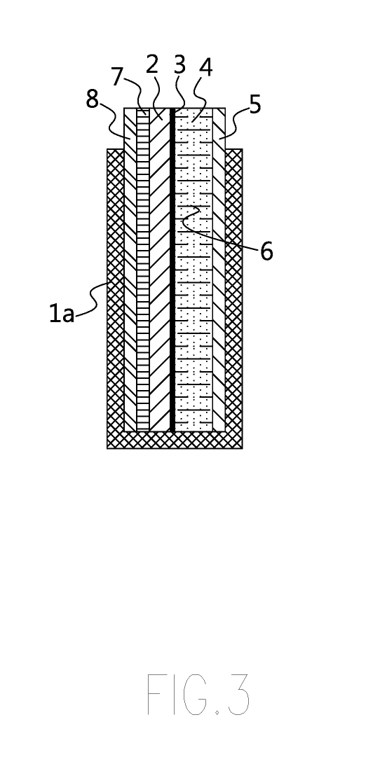

FIG. 3 is a sectional view in accordance with a third embodiment of the present invention. The battery is composed of an insulation housing 1a, a negative electrode 2, a membrane 3, an improved aqueous electrolyte 4, a positive electrode 5, a water adsorption layer 6, a conductive adhesive 7, and a solderable conductive member 8. The positive electrode 5 is a solderable electric conductor. The membrane 3 is disposed between the negative electrode 2 and the improved aqueous electrolyte 4. The water adsorption layer 6 is placed into the improved aqueous electrolyte 4. Because the negative electrode 2 is formed of magnesium or an alloy of magnesium as the main ingredient, it is not easy for soldering. Thus, another side of the negative electrode 2 is coated with a layer of the conductive adhesive 7 and the conductive adhesive 7 is attached to the solderable conductive member 8, such that the solderable conductive member 8 can be processed with soldering. The electric current passes through the solderable conductive member 8, the conductive adhesive 7, the negative electrode 2, the membrane 3, and the improved aqueous electrolyte 4 to the positive electrode 5. The conductive adhesive 7 is able to isolate water and air to prevent the negative electrode 2 from oxidation. The solderable conductive member 8 and the positive electrode 5 can be soldered with an electric wire for connection.

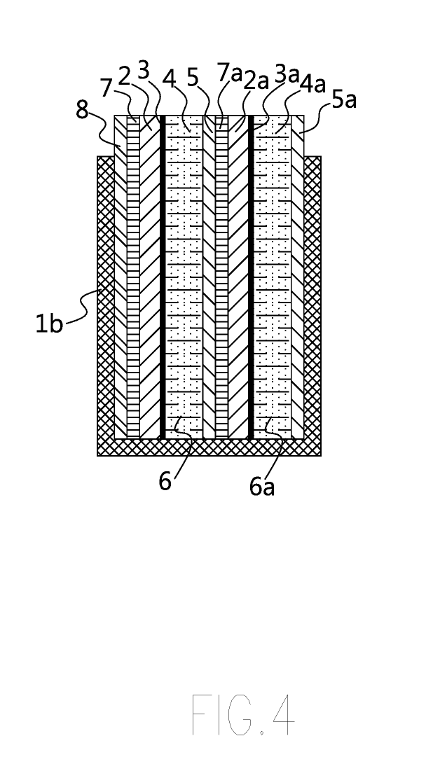

FIG. 4 is a sectional view in accordance with a fourth embodiment of the present invention. The battery is composed of an insulation housing 1b, a negative electrode 2, a membrane 3, an improved aqueous electrolyte 4, a positive electrode 5, a water adsorption layer 6, a conductive adhesive 7, a solderable conductive member 8, a negative electrode 2a, a membrane 3a, an improved aqueous electrolyte 4a, a positive electrode 5a, a water adsorption layer 6a, and a conductive adhesive 7a. The positive electrode 5 and the positive electrode 5a are solderable electric conductors. The membrane 3 is disposed between the negative electrode 2 and the improved aqueous electrolyte 4. The water adsorption layer 6 is placed into the improved aqueous electrolyte 4. The membrane 3a is disposed between the negative electrode 2a and the improved aqueous electrolyte 4a. The water adsorption layer 6a is placed into the improved aqueous electrolyte 4a. Another side of the negative electrode 2 is coated with a layer of the conductive adhesive 7, and the conductive adhesive 7 is attached to the solderable conductive member 8. Another side of the negative electrode 2a is coated with a layer of the conductive adhesive 7a, and then the conductive adhesive 7a is attached to the positive electrode 5. Thus two battery units are connected in series to form the battery. The electric current passes through the solderable conductive member 8, the conductive adhesive 7, the negative electrode 2, the membrane 3, the improved aqueous electrolyte 4, the positive electrode 5, the conductive adhesive 7a, the negative electrode 2a, the membrane 3a, and the improved aqueous electrolyte 4a to the positive electrode 5a. The solderable conductive member 8 and the positive electrode 5a can be soldered with an electric wire for connection.

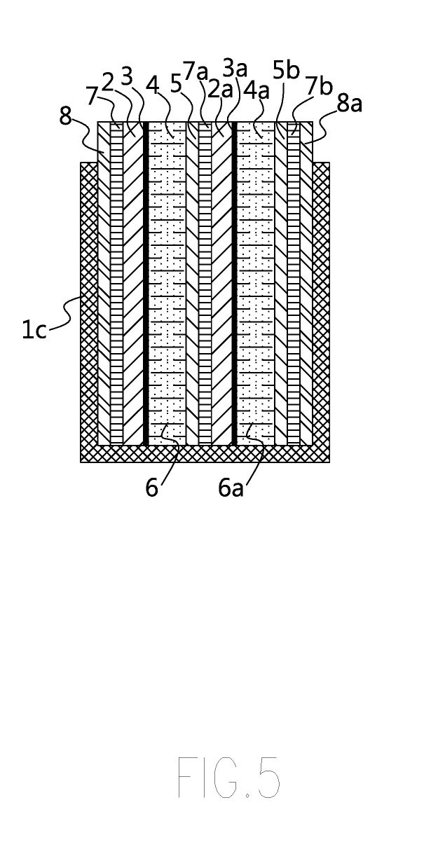

FIG. 5 is a sectional view in accordance with a fifth embodiment of the present invention. The battery is composed of an insulation housing 1c, a negative electrode 2, a membrane 3, an improved aqueous electrolyte 4, a positive electrode 5, a water adsorption layer 6, a conductive adhesive 7, a conductive adhesive 7a, a solderable conductive member 8, a negative electrode 2a, a membrane 3a, an improved aqueous electrolyte 4a, a positive electrode 5b, a water adsorption layer 6a, a conductive adhesive 7b, and a solderable conductive member 8a. The positive electrode 5 is a solderable electric conductor, and the positive electrode 5b is a non-solderable electric conductor. The membrane 3 is disposed between the negative electrode 2 and the improved aqueous electrolyte 4. The water adsorption layer 6 is placed into the improved aqueous electrolyte 4. The membrane 3a is disposed between the negative electrode 2a and the improved aqueous electrolyte 4a. The water adsorption layer 6a is placed into the improved aqueous electrolyte 4a. Another side of the negative electrode 2 is coated with a layer of the conductive adhesive 7, and the conductive adhesive 7 is attached to the solderable conductive member 8. Another side of the negative electrode 2a is coated with a layer of the conductive adhesive 7a, and then the conductive adhesive 7a is attached to the positive electrode 5. Another side of the positive electrode 5b is coated with a layer of the conductive adhesive 7b, and the conductive adhesive 7b is attached to the solderable conductive member 8a. Thus two battery units are connected in series to form the battery. The electric current passes through the solderable conductive member 8, the conductive adhesive 7, the negative electrode 2, the membrane 3, the improved aqueous electrolyte 4, the positive electrode 5, the conductive adhesive 7a, the negative electrode 2a, the membrane 3a, and the improved aqueous electrolyte 4a, the positive electrode 5b, and the conductive adhesive 7b to the solderable conductive member 8a. The solderable conductive member 8 and the solderable conductive member 8a can be soldered with an electric wire for connection.

Accordingly, the battery of the present invention includes at least one battery unit. The battery unit includes a negative electrode formed of magnesium or magnesium alloy, a water adsorption layer, an improved aqueous electrolyte, and a positive electrode. The improved aqueous electrolyte is added with at least one of acrylic acid, acrylic polymer, and acrylate polymer salt, which is able to prolong the service life of the negative electrode of the magnesium battery. The negative electrode or the positive electrode of the battery is coated with a layer of conductive adhesive, and the conductive adhesive is attached to a solderable conductive member to enhance the solderability of the negative electrode or the positive electrode. When a plurality of battery units are connected in series, the negative electrode of each battery unit is attached to the positive electrode of the adjacent battery unit by means of the conductive adhesive.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A battery, comprising at least one battery unit, the battery unit comprising a negative electrode formed of magnesium or magnesium alloy, a water adsorption layer, an improved aqueous electrolyte, and a positive electrode, the water adsorption layer adsorbing the improved aqueous electrolyte; the improved aqueous electrolyte comprising a catalyst and an additive, the additive being able to postpone an inert membrane forming on the negative electrode, the additive being selected from one of acrylic acid, acrylic polymer, and acrylate polymer salt.

2. The battery as claimed in claim 1, wherein the negative electrode or the positive electrode of the battery is coated with a layer of conductive adhesive, and the conductive adhesive is attached to a solderable conductive member to enhance solderability of the negative electrode or the positive electrode.

3. The battery as claimed in claim 1, wherein the battery comprises a plurality of battery units, the plurality of battery units are connected in series, and the negative electrode of each battery unit is attached to the positive electrode of the adjacent battery unit by means of a conductive adhesive.
